(19) United States
(12) Patent Application Publication
(10) Pub. No.: US 2024/0356317 A1
(43) Pub. Date: Oct. 24, 2024

(54) Adjustable-Depth Electrical Boxes

(71) Applicant: ERICO International Corporation, Solon, OH (US)

(72) Inventors: Michael Hung-Sun Oh, Twinsburg, OH (US); James Anthony Bukowski, Akron, OH (US)

(21) Appl. No.: 18/642,619

(22) Filed: Apr. 22, 2024

Related U.S. Application Data
(60) Provisional application No. 63/497,813, filed on Apr. 24, 2023.

(51) Int. Cl. H02G 3/08; H02G 3/12; H02G 3/14

(52) U.S. Cl. CPC H02G 3/081; H02G 3/14; H02G 3/123

(57) ABSTRACT

An electrical box assembly for adjustable-depth mounting of an electrical box relative to a support structure. The electrical box assembly can include a centerplate with a centerplate opening and an electrical box with an electrical box housing, a back plate removably attached to the electrical box housing, and an extendable sleeve configured to receive fasteners of electrical devices. The electrical box can be received within the centerplate opening, with the electrical box housing secured to the centerplate. The extendable sleeve can be selectively slidable within the electrical box housing.

### CROSS-REFERENCE TO RELATED APPLICATIONS

This application claims priority to and incorporates by reference U.S. Provisional Patent Application No. 63/497,813, filed Apr. 24, 2023.

### BACKGROUND

In many applications, it may be useful to adjust the depth of electrical boxes during or after installation relative to support structures, for example, wall or ceiling structures of buildings. In some cases, it may be useful to adjust electrical boxes relative to a particular support structure to provide a flush alignment with the front of the electrical box and an outer surface of the wall structure. Further, in some applications, it may be useful to pre-install electrical devices within an electrical box, with final termination of the electrical devices occurring at another location.

### SUMMARY

Some embodiments of the invention provide an electrical box assembly for adjustable-depth mounting of an electrical box relative to a support structure, the electrical box assembly can include a centerplate with a centerplate opening and an electrical box. The electrical box can include an electrical box housing, a back plate removably attached to the electrical box housing, an extendable sleeve that includes a plurality of mounting tabs arranged to secure three or more electrical devices at an open front side of the extendable sleeve. The electrical box can be received within the centerplate opening, with the electrical box housing secured to the centerplate. The extendable sleeve may be selectively slidable within the electrical box housing.

Some embodiments of the invention provide an adjustable depth electrical box including an electrical box housing, and a back plate removably attached to the electrical box housing. The back plate may include a far side support that can be selectively adjustable to a plurality of extension distances to support the electrical box housing relative to a building structure opposite the back plate. The adjustable depth electrical box may also include an extendable sleeve positioned at least partially within the electrical box housing to secure one or more electrical devices, and an adjustment fastener axially fixed relative to the electrical box housing and rotatable relative to the electrical box housing to move the extendable sleeve between a retracted position and an extended position.

Some embodiments of the invention provide a method of installing an electrical box assembly. The method may include affixing a centerplate of the electrical box assembly to a building support structure, to support a housing of an electrical box relative to the building support structure, with an extendable sleeve of the electrical box that may be slidably supported within the housing, and may support electrical devices at a front side of the electrical box assembly. The method may include installing a back plate on a far side of the electrical box housing. The method may include adjusting the extendable sleeve of the electrical box housing relative to the electrical box housing to change a depth of the electrical devices relative to the building support structure.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front axonometric view of an electrical box assembly in a retracted, closed-back, configuration according to an embodiment of the invention;

FIG. 2 is a rear axonometric view of the electrical box assembly of FIG. 1 with a back plate in a first configuration according to an embodiment of the invention;

FIG. 3 is a top plan view of the electrical box assembly of FIG. 1;

FIG. 4 is a bottom plan view of the electrical box assembly of FIG. 1;

FIG. 5 is a rear axonometric view of the electrical box assembly of FIG. 1 in an open-back configuration according to an embodiment of the invention;

FIG. 6 is a top plan view of the electrical box assembly of FIG. 1 with a support in a bent configuration according to an embodiment of the invention;

FIG. 7 is a top plan view of the electrical box assembly of FIG. 1 with the support in another bent configuration according to an embodiment of the invention;

FIG. 8 is a rear axonometric view of the electrical box assembly of FIG. 1 with the back plate in a second configuration according to an embodiment of the invention;

FIG. 9 is a front axonometric view of the electrical box assembly of FIG. 1 in an extended position according to an embodiment of the invention;

FIG. 10 is a front axonometric view of an electrical box assembly in a retracted configuration according to another embodiment of the invention;

FIG. 11 is a rear axonometric view of the electrical box assembly of FIG. 10;

FIG. 12 is a front axonometric view of an electrical box assembly in a retracted configuration according to another embodiment of the invention;

FIG. 13 is a rear axonometric view of the electrical box assembly of FIG. 12;

FIG. 14 is a front axonometric view of an electrical box assembly in a retracted configuration according to another embodiment of the invention;

FIG. 15 is a rear axonometric view of the electrical box assembly of FIG. 14;

FIG. 16 is a front axonometric view of an electrical box assembly according to an embodiment of the invention;

FIG. 17 is a rear axonometric view of the electrical box assembly of FIG. 16 with a back plate in a first configuration according to an embodiment of the invention;

FIG. 18 is a front plan view of the electrical box assembly of FIG. 16;

FIG. 19 is a rear plan view of the electrical box assembly of FIG. 16;

FIG. 20 is a top plan view of the electrical box assembly of FIG. 16, with the back plate in the first configuration according to an embodiment of the invention;

FIG. 21 is a top plan view of the electrical box assembly of FIG. 16, with the back plate in a second configuration according to an embodiment of the invention;

FIG. 22 is a top plan view of the electrical box assembly of FIG. 16, with the back plate in a third configuration according to an embodiment of the invention;

FIG. 23 is a top plan view of the electrical box assembly of FIG. 16, with the back plate in a fourth configuration according to an embodiment of the invention;

FIG. 24 is a front axonometric view of the electrical box assembly of FIG. 16 supported between building structures;

FIG. 25 is a rear axonometric view of the electrical box assembly of FIG. 16 supported between building structures;

FIG. 26 is an axonometric view of the electrical box assembly of FIG. 16 supported by a building structure;

FIG. 27 is a front axonometric view of an electrical box assembly according to an embodiment of the invention;

FIG. 28 is a rear axonometric view of the electrical box assembly of FIG. 27;

FIG. 29 is a front axonometric view of an electrical box assembly according to an embodiment of the invention;

FIG. 30 is a rear axonometric view of the electrical box assembly of FIG. 29;

FIG. 31 is a front axonometric view of an electrical box assembly according to an embodiment of the invention; and

FIG. 32 is a rear axonometric view of the electrical box assembly of FIG. 31.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to adjust the depth of electrical boxes (or other components) of an electrical box assembly relative to a support structure (e.g., a wall stud). For example, after installation of support structure coverings (e.g., drywall, wood, tile, or a combination thereof), a front opening of an electrical box assembly may not be flush with an outward facing surface of the support structure covering. This can happen for a number of reasons, including, for example, because different structure support coverings can define a range of finished depths. Therefore, in order to comply with industry requirements, it may be necessary to adjust the depth of an electrical box relative to a particular support structure to bring the front opening of the electrical box flush with the support structure covering.

Additionally, support structures can have different depths and can be formed from materials, such as, for example, wood or metal. Some support structures can have a depth dimension of 2½″, 3½″, 3⅝″, 4″, 5½″, 6″, among others. Embodiments of the invention can provide an electrical box that can be secured to a support structure, sized to fit within wall spaces of different depths, and be adjustable to extend the electrical box to bring the front opening of the electrical box flush with a support structure covering.

In some contexts, it may be useful to provide accessibility to the rear of the electrical box after installation on the support structure. For example, it may be advantageous to pre-install electrical devices (e.g., switches, receptacles, etc.) within the electrical box at a first, assembly, location and terminate the electrical connections later at a second, installation, location. A back plate configured to be removable from the electrical box can allow selective access to the electrical devices through a rear opening of the electrical box for termination of electrical connections at the installation location without the removal of the electrical devices from the electrical box.

As noted above, embodiments of the electrical box can be sized to fit within wall spaces of various depths. Therefore, in some installation configurations, a far side support can be provided on the back plate to provide support of the electrical box within wall spaces of different depths. For example, the far side support can contact a support structure or support structure covering disposed opposite the back plate to stabilize and support the electrical box relative to the support structure or support structure covering. In some embodiments, the far side support may be adjustable to stabilize and support electrical boxes relative to a support structure or support structure covering that is disposed a variable distance from the back plate. For example, a bendable far side support rigidly secured to a back plate may provide support at a variety of distances across a variety of unbent and bent configurations.

Further, associated methods for terminating electrical devices within an electrical box of an electrical box assembly, support of the electrical box assembly within a wall space, and adjustment of the depth of the electrical box relative to a support structure are also contemplated by the proposed electrical box assembly. In some embodiments, the methods for terminating electrical connections of the electrical devices can be performed after the electrical box assembly has been installed on the support structure and support structure coverings have been installed.

Embodiments of the invention are presented below in the context of particular support structures, including stud-framed walls. Although these configurations can be particularly useful in some contexts, including due to the particular requirements for mounting electrical boxes to a wall stud, other configurations are possible. For example, the principles disclosed herein—and embodiments of the invention—can be used with support structures other than those expressly illustrated or discussed, with mounting structures (e.g., telescoping or other brackets attached to and between wall studs), or in a variety of other contexts. Similarly, although particular configurations of electrical box assemblies are illustrated and discussed below, some embodiments of the invention can be used with electrical boxes having different configurations (e.g., more or less gangs, different shapes and depths, etc.).

Generally, embodiments of the invention can include an electrical box with an electrical box housing and an extendable sleeve moveable relative to the electrical box housing to adjust the overall depth of the electrical box. The extendable sleeve can be fully retained within the electrical box housing in a retracted position. The extendable sleeve can be coupled to the electrical box housing with a threaded fastener. Generally, in this regard, adjustment of the threaded fastener can move the extendable sleeve in an axial direction defined by the threaded fastener, relative to the electrical box housing.

In some embodiments, the invention can include a centerplate that includes a plate body and one or more flanges that are collectively configured to secure and support the electrical box relative to the plate body. In some cases, the centerplate can be directly mounted to a support structure, including stud-framed walls, or coupled to a support bracket that can be mounted to a pair of support structures.

In some embodiments, the threaded fastener can be a ribbed fastener, such as a fastener with threads or circumferential ridges. For example, some embodiments can include a threaded fastener that is rotatable but not translatable relative to the electrical box housing. The threaded fastener can accordingly be rotated by a user in order to cause a translational adjustment of the extendable sleeve relative to the electrical box housing. For example, rotation of the threaded fastener may cause translational movement of an extendable sleeve via engagement with a threaded fastener opening on the extendable sleeve.

In some embodiments, it may be useful to arrange the extendable sleeve and the electrical box housing so that the fastener extends within the interior of the electrical box. In some such embodiments, the fastener may be adjustable from within the electrical box. For example, a housing tab extending into the electrical box housing may rotatably and non-translatably secure the threaded fastener that extends from the extendable sleeve through threaded sleeve tab on the extendable sleeve. A user can then engage a head of the fastener from within the electrical box, and rotate the fastener to cause the extendable sleeve to be translated relative to the electrical box housing via the threaded engagement of the fastener with the sleeve tab and the non-translatable engagement of the fastener with the housing tab.

The ability to adjust the mounting depth of an electrical box by engaging a fastener within the interior of the electrical box may be useful, for example, in order to facilitate easier adjustment of the electrical box after a wall covering (e.g., drywall, wood-paneling, tile, etc.) has been installed.

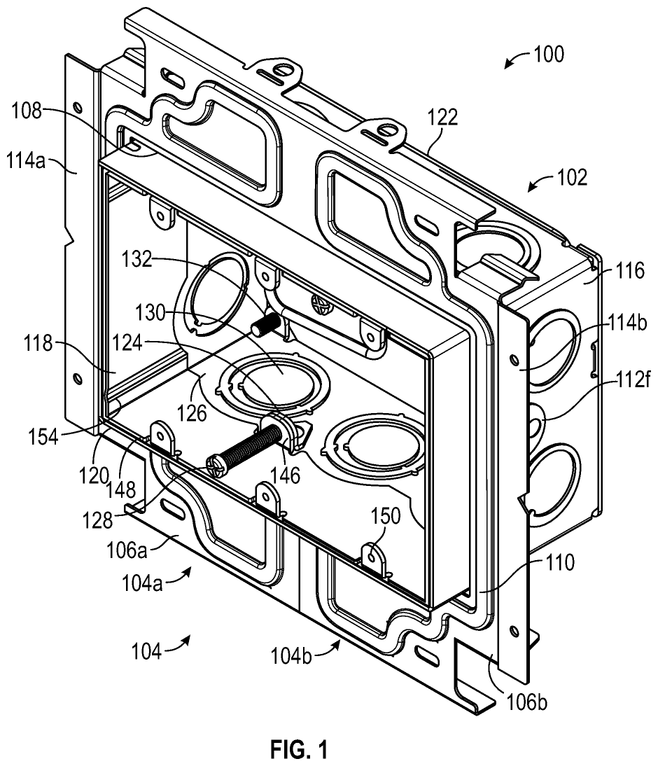

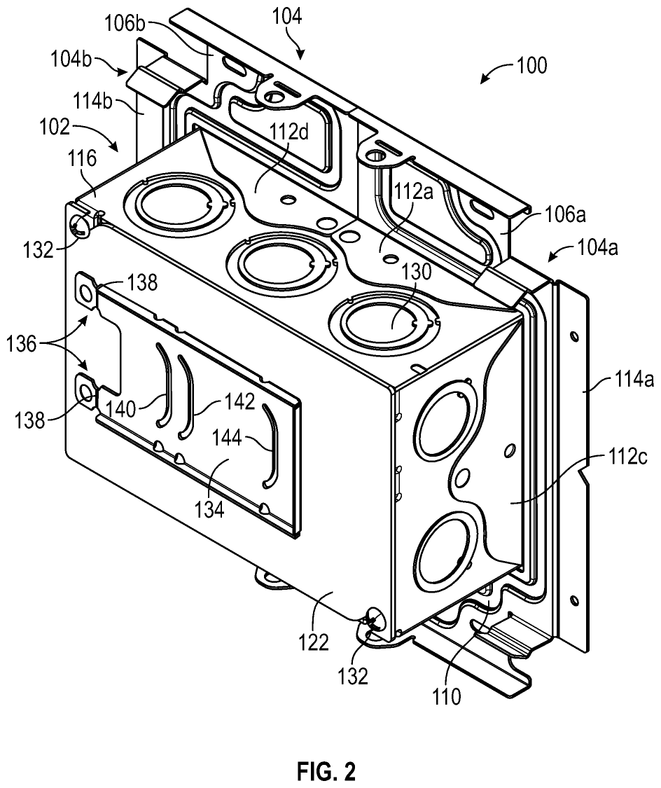

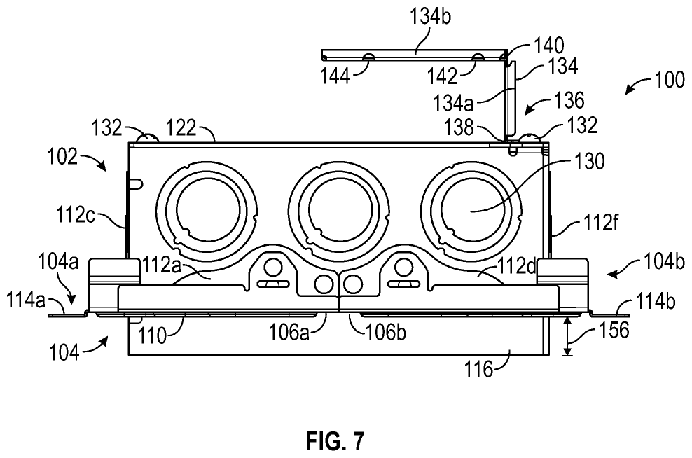

Referring to FIGS. 1 through 9, an example electrical box assembly 100 is shown according to an embodiment of the invention. In the illustrated example, the electrical box assembly 100 includes an electrical box 102 (shown here as a 3-gang electrical box) and a centerplate 104. As shown, the centerplate 104 can include a set of identical centerplate halves (i.e., a first center plate half 104a and a second centerplate half 104b), with the second centerplate half 104b rotated 180 degrees relative to the first centerplate half 104a. This can allow the centerplate 104 to be manufactured with particular efficiency. Each of the centerplate halves 104a, 104b has a plate body 106a, 106b, respectively, and combine to form a plate opening 108 configured to receive the electrical box 102 therein. As shown in FIG. 2, the plate opening 108 is sized and configured to closely follow the shape of the electrical box 102. This can provide for stable support thereof. The plate bodies 106a, 106b can include a stiffening feature, here shown as an embossment 110, stamped or otherwise formed therein. In other embodiments, however, other configurations are possible, including configurations in which a centerplate does not fully surround all exterior sides of an electrical box (e.g., as shown in FIGS. 7 through 12) or in which the centerplate is formed as one, unitary, element.

Each of the centerplate halves 104a, 104b has a set of centerplate flanges. As shown in FIGS. 2 and 4, the first centerplate half 104a has a first centerplate flange 112a, a second plate flange 112b, and a third centerplate flange 112c extending from the plate body 106a. Similarly, as shown in FIGS. 1, 2, and 4, the second centerplate half 104b has a fourth centerplate flange 112d, a fifth centerplate flange 112e, and a sixth centerplate flange 112f extending from the plate body 106b. In the illustrated embodiment, the centerplate flanges 112a, 112b, 112c, 112d, 112e, 112f are integrally formed with the plate bodies 106a, 106b and extend adjacent the plate opening 108, in particular from a connection to the plate bodies 106a, 106b at an edge of the plate opening 108. The centerplate flanges 112a, 112b, 112c, 112d, 112e, 112f are configured to extend at least partially along the electrical box 102 and be affixed thereto (e.g., by welding or fasteners). In other embodiments, however, other configurations are possible.

Further, looking at FIG. 1, the centerplate 104 has a set of mounting flanges. The set of mounting flanges includes a first mounting flange 114a extending outward from the plate body 106a and a second mounting flange 114b extending outward from the plate body 106b in a direction opposite that of the first mounting flange 114a. The first and second mounting flanges 114a, 114b are each configured to securely attach the centerplate 104 to a support structure (e.g., a wall stud) (not shown). For example, the first mounting flange 114a is configured to engage a wall stud to mount the centerplate 104 thereto by being placed flush against the face of the wall stud and secured thereto with fasteners.

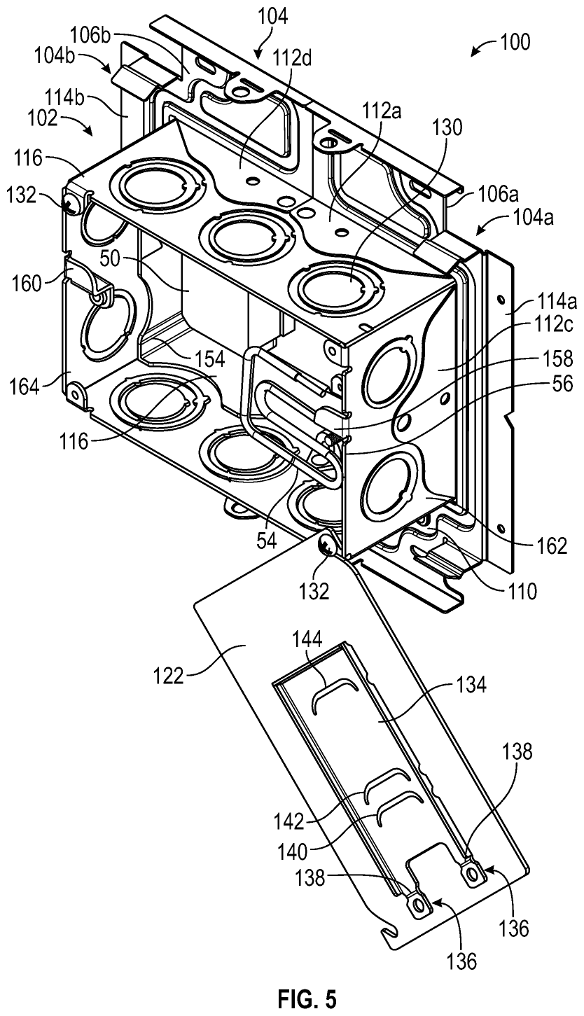

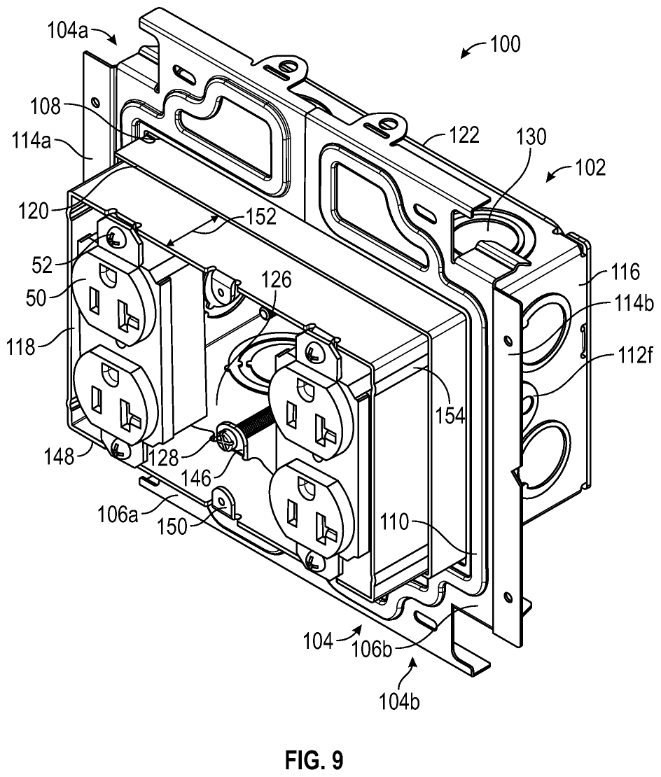

The electrical box 102 includes an electrical box housing 116 and an extendable sleeve 118. The electrical box housing 116 has a front opening 120 and a back plate 122 (shown in FIG. 2) opposite the front opening 120. A housing tab 124 extends inward into the electrical box housing 116 from a first side wall 126 of the electrical box 102 and is configured to retain an adjustment fastener 128 therein and permit rotation of the threaded adjustment fastener 128 but not translation relative to the electrical box housing 116 and the housing tab 124. For example, the adjustment fastener 128 can be rotatable relative to the housing tab 124 but can be translationally (axially) fixed relative thereto (e.g., via riveting or peening of the fastener, use of E-, C-, or another type of clip, use of an integral or removable collar, or another technique). In some embodiments, the housing tab 124 can be secured to the electrical box housing 116 through welding (e.g., spot welding), however the housing tab 124 may alternatively be secured to the electrical box housing 116 via rivets, a fastener, or may instead be integrally formed with the electrical box housing 116 (e.g., stamped therefrom). In some embodiments, the adjustment fastener 128 can be located on the first side wall 126 in a location configured to be between adjacent electrical devices (e.g., shown next to an electrical outlet 50 in FIG. 9) and spaced between nearby knockouts 130 (shown in FIG. 5), to prevent potential contact with electrical conductors entering and leaving the electrical box 102 through the knockouts 130.

The back plate 122 of the electrical box 102 is removably attached to the electrical box 102 via a set of back plate fasteners 132 as shown in FIGS. 2 and 5. As stated above, it may be useful to access the rear of the electrical box 102 after installation on the support structure. For example, it may be advantageous to pre-install electrical devices (e.g., the electrical receptacles 50 shown in FIGS. 5 and 9) within the electrical box 102 at a first location and terminate the electrical connections of the electrical receptacles 50 with electrical conductors at a second location. Therefore, the removability of the back plate 122 provides selective access to the rear of the electrical receptacles 50, and corresponding termination points, from within the electrical box for termination thereof at an installation location without having to remove the electrical receptacles 50 from the electrical box 102.

Additionally, the back plate 122 has a far side support 134 extending therefrom and coupled thereto at a far side joint 136 (e.g., tabs for spot welding or other securement, as shown). A far side of the electrical box 102 can be defined as the side of the electrical box 102 farthest from a support structure to which the electrical box assembly 100 is mounted. The far side support 134 is configured to be selectively arranged relative to the back plate 122 to provide support of the far side of the electrical box 102, in walls of different depths, by contacting an inside surface of a wall covering (e.g., drywall) attached to a face of a support structure opposite the face on which the mounting flange 114a is mounted (as arranged as shown in FIG. 2). The far side support 134 can stabilize the electrical box 102 and prevent the electrical box 102 from being pushed back into the wall space during construction, during installation of electrical devices, and during use (e.g., in the case of an electrical outlet such as, for example, the electrical outlet 50 coupled to the electrical box 102 shown in FIG. 9, when an electrical device is plugged into the electrical outlet 50).

Further, because the back plate 122 is removable, the typical location for an equipment grounding termination on the rear wall of an electrical box was no longer preferable. As shown in FIG. 5, the electrical box housing 116 includes a set of grounding tabs, including a first grounding tab 158 and a second grounding tab 160, extending inward from opposing side walls (e.g., second side wall 162 and third side wall 164) of the electrical box 116. An equipment grounding conductor can be secured to at least one of the first or second grounding tabs 158, 160 via a fastener (e.g., the equipment grounding conductor 54 and the equipment grounding screw 56). The equipment grounding conductor may aid the grounding of a plurality of electrical devices (e.g., the electrical receptacles 50 shown in FIGS. 5 and 9). For example, the equipment grounding conductor may aid the grounding of three or more electrical devices. In other embodiments, however, other configurations are possible. For example, in some embodiments only one grounding tab can be included or one or more of grounding tabs can be located elsewhere on an electrical box housing.

The far side support 134 can be arranged to accommodate multiple inner wall depths. For example, when the electrical box assembly 100 is installed in a wall with an internal wall depth of 2½″, the far side support 134 can be arranged in a first unbent position, as shown in FIG. 2, in which the far side support 134 extends along and substantially parallel to the back plate 122 (e.g., unbent and otherwise unaltered from an as-shipped configuration). as described further below, to provide far side support for walls having an internal depth greater than 2½″, the far side support 134 can be bent into various arrangements to provide such support.

As shown in FIG. 2, the far side support 134 has a set of reliefs, including a first relief 138, a second relief 140, a third relief 142, and a fourth relief 144, at which the far side support 134 at which the far side support 134 can be selectively bent and which can correspond to common inner wall depths (e.g., 3⅝″, 4″, 5½″, 6″). In some embodiments, the first, second, third, and fourth reliefs 138, 140, 142, 144 may include a plurality of perforations, cutouts, scores, or other areas of weakened material, that may case the bending of the far side support 134 in the field during installation. For example, the reliefs 138, 140, 142, 144 may each include a cutout at least partially spanning a width of the far side support 134, and a notch disposed at each edge of the far side support adjacent ends of the cutout. As described above, the combination of the cutout and notches may weaken the far side support 134 to allow workers to manually bend the far side support 134 during installation.

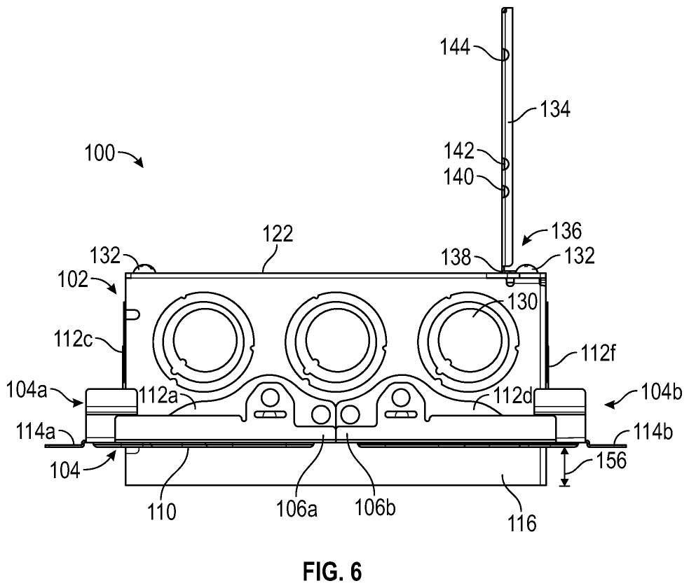

As discussed above, the reliefs 138, 140, 142, 144 can be bent to adjust an extension of the far side support 134. For example, in a second bent position, the far side support 134 can be bent at the first relief 138 (as shown in FIG. 6) to arrange the far side support 134 substantially perpendicular with respect to the back plate 122. Consequently, a distal end of the far side support 134 may be disposed a first distance from the back plate 122. The first distance may be a maximum extension distance or length of the far side support 134. The far side support 134 in the second bent position may be configured to contact a building structure disposed about 6 inches from the first and second mounting flanges 114a, 114b. The second bent position may therefore be utilized for installation in a wall space with an internal wall depth of 6 inches.

Continuing, for installation in a wall space with an internal depth of less than 6 inches, the far side support 134 can be selectively bent at the reliefs 140, 142, 144, to adjust an extension of the far side support 134 relative to the back plate 122. For example, in a third bent position, the far side support 134 can be bent a first time at the first relief 138, and can be bent a second time at the second relief 140 to reduce an extension of the far side support 134. As illustrated in FIG. 7, a proximal portion 134a of the far side support 134 may extend substantially perpendicularly from the back plate 122 to a bend at the second relief 140. Furthermore, a distal portion 134b of the far side support 134 may extend from the bend at the second relief 140 substantially perpendicular to the proximal portion 134a. The distal portion 134b may therefore be arranged substantially parallel with the back plate 122. In the third bent position, the distal portion 134b may be spaced a second distance (e.g., a distance shorter than the first distance) from the back plate. The far side support 134 in the third bent position may be configured to contact a building structure disposed about 3 ⅝ inches from the first and second mounting flanges 114a, 114b. The third bent position may therefore be utilized for installation in a wall space with an internal wall depth of 3⅝ inches.

In a fourth bent position, the far side support 134 can be bent a first time at the first reliefs 138, and can be bent a second time at the third relief 142 to reduce an extension of the far side support 134. Somewhat similar to the illustration of FIG. 7, in the fourth bent position, a proximal portion 134a of the far side support 134 may extend substantially perpendicularly from the back plate 122 to a bend at the third relief 142. Furthermore, a distal portion 134b of the far side support 134 may extend from the bend at the third relief 142 transverse to the proximal portion 134a. The distal portion 134b may therefore be arranged substantially parallel with the back plate 122. In the fourth bent position, the distal portion 134b may be spaced a third distance (e.g., a distance shorter than the first distance, but longer than the second distance) from the back plate 522. The far side support 134 in the fourth bent position may be configured to contact a building structure disposed about 4 inches from the first and second mounting flanges 114a, 114b. The fourth bent position may therefore be utilized for installation in a wall space with an internal wall depth of 4 inches.

In some embodiments, the far side support 134 in a fifth bent position can be bent at the fourth relief 144 instead of the second or third relief 140, 142 to provide far side support in wall spaces with internal wall depths of 5½ inches. However, other configurations are possible, including as discussed below.

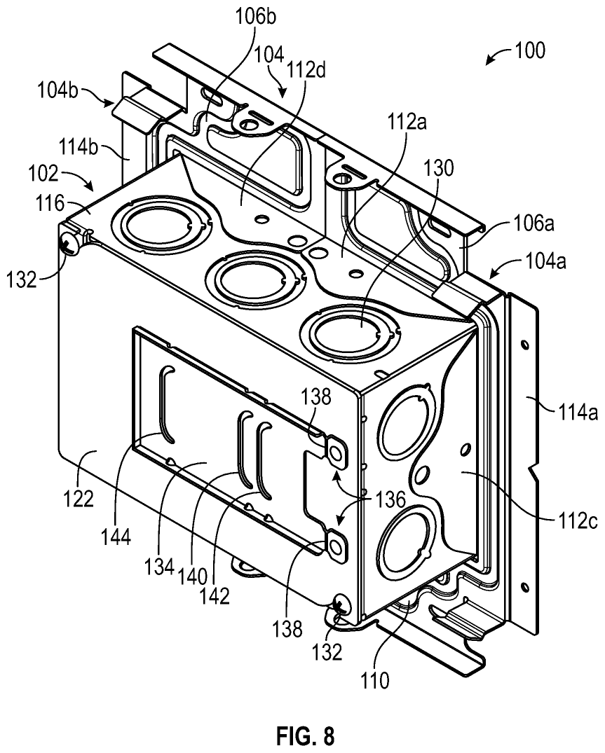

As discussed above, the back plate 122 of the electrical box 102 is removably attached to the electrical box 102 via a set of back plate fasteners 132. Therefore, the back plate 122 can arranged in an orientation rotated 180 degrees from the orientation shown in FIGS. 2 and 5 with the far side joint 136 closest to the second mounting flange 114b. For example, as shown in FIG. 8, the far side support 134 can be arranged with the far side joint 136 closer to the first mounting flange 114a. This adaptability permits mounting the centerplate 104 and the electrical box 102 to either side of a structural support and, if an embodiment of the electrical box has an arrangement of knockouts that is not the same on top as on bottom (i.e., not as shown, wherein all the knockouts 130 are nested-knockouts capable of selectively receiving electrical connectors of ½″, ¾″, and 1″ sizes), being able to turn the electrical box assembly 100 over to provide the appropriately sized knockouts in the positions required.

Continuing, the extendable sleeve 118 is configured to be received through the front opening 120 of the electrical box housing 116 and movable relative thereto. The extendable sleeve 118 includes a sleeve tab 146. The sleeve tab 146 is threaded and configured to threadably receive the adjustment fastener 128. The adjustment fastener 128 effectively couples the extendable sleeve 118 to the electrical box housing 116. The extendable sleeve 118 also includes a front opening 148 and mounting tabs 150 extending inward into the front opening 148 that are configured to receive device fasteners to secure electrical devices to the extendable sleeve 118 (e.g., device fasteners 52 securing the electrical outlets 50 to the extendable sleeve 118 as shown in FIG. 9). As illustrated in FIG. 9, the mounting tabs 150 can be spaced to secure three electrical devices to the extendable sleeve 118, however as discussed further below, more sets of mounting tabs 150 may be added to secure extra electrical devices. However, other configurations are contemplated.

In some embodiments, the dimensions of the extendable sleeve 118, including the placement of the mounting tabs 150, can be the same as a standard, non-adjustable, electrical boxes (e.g., masonry boxes of standard sizes and dimensions, wherein the mounting tabs are integrated with the electrical box). As noted above, the extendable sleeve 118 is extendable between a retracted position (shown in FIGS. 1 through 8) and an extended position (shown in FIG. 9) and any position in-between. The adjustment fastener 128 is threadedly engaged with threads in the sleeve tab 146 of the extendable sleeve 118. Accordingly, when the adjustment fastener 128 is rotated, the threaded engagement of the adjustment fastener 128 with the sleeve tabs 146 and the rotatable but non-translational engagement of the adjustment fastener 128 with the housing tab 124, can collectively cause the extendable sleeve 118 to move axially along the adjustment fastener 128. Thus, via rotation of the adjustment fastener 128 and corresponding axial movement of the adjustment fastener 128 through the sleeve tab 146, the extendable sleeve 118 can be secured at any of a plurality of depths relative to the electrical box housing 116. For example, in the retracted position, the front opening 148 of the extendable sleeve 118 is flush with the front opening 120 of the electrical box housing 116 and in the extended position, the front opening 148 of the extendable sleeve 118 is spaced a first distance 152 from the front opening 120 of the electrical box housing 116. In some embodiments, the first distance 152 can be in the range of about zero inch to about 1.5 inch.

As described above, one of the sleeve tabs 146 and one of the housing tabs 124 (e.g., a pair of adjustment tabs) may cooperatively receive the adjustment fastener 128, to allow an extension of the sleeve 118 to be adjusted axially relative to the adjustment fastener 128. As illustrated in FIG. 1, the pair of adjustment tabs 124, 146 may be radially offset from each of the mounting tabs 150 (e.g., relative to an axis extending through a center of the adjustment fastener) and correspondingly laterally offset from the mounting tabs 150 along the front opening 148 of the sleeve 118. As illustrated in FIG. 9, the offset between the pair of adjustment tabs 124, 146 and the mounting tabs 150 may advantageously allow the adjustment fastener 128 to be accessed and adjusted through the front openings 120, 148 and between electrical devices (e.g., the electrical outlets 50) installed in the electrical box assembly 100.

The extendable sleeve 118 can also include protruding ribs 154 (shown in FIG. 9) extending along the exterior of at least one of the sides of the extendable sleeve 118. The protruding ribs 154 are configured to maintain contact with the electrical box housing 116 before, during, and after adjusting the depth of the extendable sleeve 118 to maintain a close fit and electrical continuity therebetween. Additionally, or alternatively, in some embodiments an electrical box housing can include protruding ribs configured to maintain contact with an extendable sleeve.

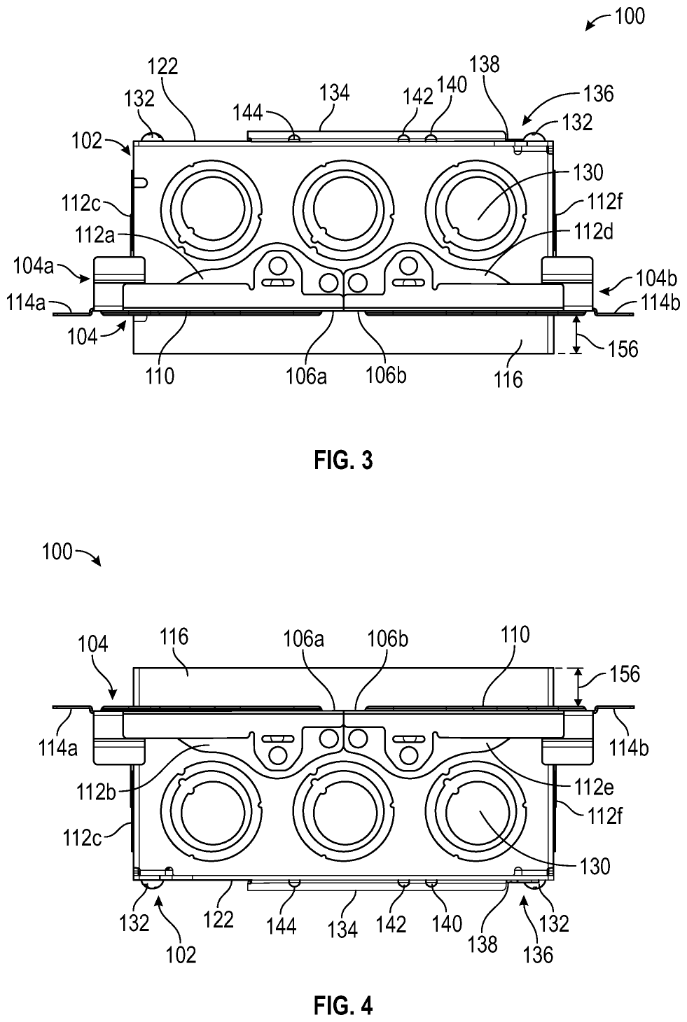

In some embodiments, as shown here, the electrical box 102 can be initially spaced a distance from the centerplate 104. As shown in FIG. 3, with the extendable sleeve 118 in the retracted position, the electrical box housing 116 is secured to the centerplate 104 with the front opening 120 positioned a second distance 156 from the centerplate 104. In some embodiments, the second distance 156 can be predetermined based on a standard wall covering thickness. For example, the second distance 156 can be about 0.5 inch to about 0.625 inch based on common thicknesses for drywall. In some embodiments, the second 156 distance can be shorter in situations in which the wall covering thickness is unknown. Affixing the centerplate flanges 112a, 112b, 112c, 112d, 112e, 112f to the electrical box housing 116 also maintains the distance between the centerplate 104 and the knockouts 130 during and after box depth adjustment.

Continuing, depth adjustment of the electrical box 102 from within the electrical box 102 through the front openings 120, 148 can be advantageous to ensure the mounting tabs 150 of the extendable sleeve 118 are flush with a structural support covering, as described above, when finishing an electronic device installation. For example, in some construction scenarios a combustible wall covering panel (e.g., wood paneling), ceramic tile, or another material is applied to the structural supports in addition to drywall and extension rings (not shown) would be required to be installed to extend the depth of the electrical box to be flush with the outer surface of the additional wall covering to prevent the possibility of a spark from an electrical device (e.g., a luminaire not shown) or wiring connections within the electrical box 102 from igniting the wood paneling or escaping the electrical box. Additionally, longer device fasteners would be required to reach the mounting tabs within the electrical box. The ability to adjust the depth of the electrical box 102 relative to the structural support covering, and any additional wall coverings, eliminates the need to buy, carry, and install extension rings and longer device fasteners to ensure installation requirements are met.

FIGS. 1 through 8 and 9 illustrate the installation and adjustment of the electrical box 102 in a wall space with an internal depth of 3⅝″. FIGS. 1 through 4 show the electrical box assembly 100 (i.e., the electrical box 102 and the centerplate 104), as it can be attached to a structural support by securing the first mounting flange 114a of the first centerplate half 104a thereto. The electrical box assembly 100 is configured to be mounted to extend away from either lateral side of the support structure.

The installation can also include orienting the back plate 122 so the far side joint 136 of the far side support 134 is positioned nearer the far side of the electrical box housing 116. Further, the electrical box 102 can be installed in the retracted position with the front opening 148 of the extendable sleeve 118 flush with the front opening 120 of the electrical box housing 116. FIG. 5 illustrates partially removing (fully removing is also contemplated) the back plate 122 from the electrical box housing 116 to provide access to electrical devices (shown as electrical receptacles 50). In some installation scenarios, the electrical devices are pre-installed in the electrical box in a first location and then final electrical terminations are made at a second, installation, location. Therefore, permitting access through the back of the electrical housing 116 to make the final electrical terminations from the back eliminates the need to remove the electrical devices and make the final electrical terminations through the front of the electrical housing 116. With the back plate 122 installed and properly oriented, the far side support 134 can be arranged to provide far side support within the wall space. For example, in a wall space with an internal depth of 3⅝″, the far side support 134 can be bent away from the back plate 122 at the first reliefs 138 and bent back toward the back plate 122 at the second relief 140 to extend substantially parallel therewith as shown in FIGS. 6 and 7. Then, as shown in FIG. 9, after structural support coverings are installed, the extendable sleeve 118 can be extended if necessary to bring the mounting tabs 150 are flush with the exterior side of the structural support covering. Moving the extendable sleeve 118 from the retracted position as shown in FIG. 1 to the extended position as shown in FIG. 9, can be accomplished by turning the adjustment fastener 128, with or without electrical devices already installed. For example, to case installation and adjustment of the electrical box assembly 100, the adjustment fastener 128 can be accessed through the front opening 120, between electrical devices installed in the electrical box assembly 100 (e.g., the outlets 50 illustrated in FIG. 9, or one of the outlets 50 as shown and a similar third outlet also installed onto the sleeve 118 (not shown)). Additionally, because the electrical box housing 116 is fixed relative to the centerplate 104 through the affixing of the centerplate flanges 112a, 112b, 112c, 112d, 112e, 112f to the electrical box housing 116, electrical conduit can be installed on the electrical box housing 116 at the knockouts 130 prior to depth adjustment of the electrical box 102 via the extendable sleeve 118.

As discussed herein, unless otherwise indicated, “translationally fixed” and the like does not necessarily indicate an absolutely fixed arrangement, in which zero translational movement is permitted. Rather, some translationally fixed components (e.g., the adjustment fastener 128) may be able to move translationally somewhat, but only to a certain amount and generally not so as to provide meaningful translational adjustment of a corresponding component (e.g., the extendable sleeve 118). For example, depending on how the adjustment fastener 128 is fixed to the housing tab 124, the adjustment fastener 128 may be able to move slightly in the axial direction, relative to the housing tab 124 (e.g., by 1-5 mm or 1-3% of the axial length of the adjustment fastener 128 or of the total depth of the electrical box 102).

In some embodiments, other aspects of the configuration illustrated in FIGS. 1 through 9 can also be changed while preserving similarly beneficial adjustability. For example, in some embodiments, fasteners may be translationally fixed relative to a housing tab and may engage a threaded feature at a different location on or in an extendable sleeve. Or a fastener threadedly engaged with a housing tab and translationally fixed but rotatable relative to an extendable sleeve. Similarly, although configurations with a single housing tab may provide sufficient balance between stability and ease of adjustment, a set of opposing housing tabs (e.g., on opposing sides or corners) or other configurations including a different number of housing tabs, or one or more housing tabs disposed differently relative to an electrical box housing than is illustrated in FIGS. 1 through 9, may be advantageous. Some examples of which are discussed below.

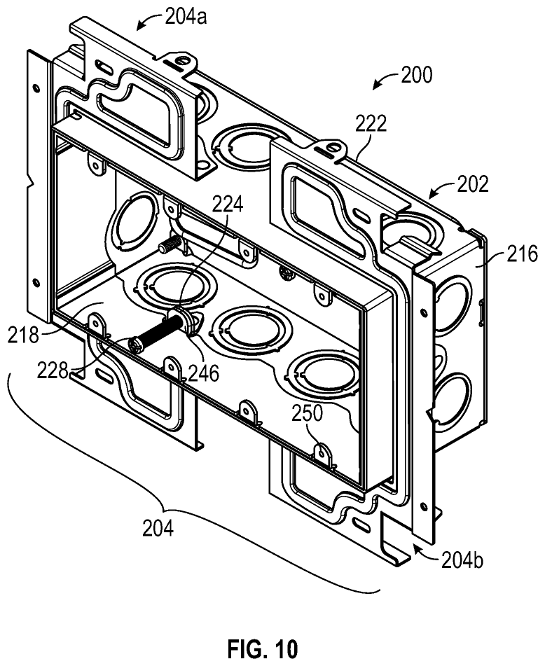

FIGS. 10 through 15 illustrate other embodiments of an electrical box assembly 200, 300, 400 according to the invention, as also can be mounted to structural support member. In many aspects, the electrical box assemblies 200, 300, 400 are similar to the electrical box assembly 100 described above and similar numbering in the 200, 300, and 400 series are used for the electrical box assemblies 200, 300, 400, respectively. Correspondingly, discussion of the electrical box assembly 100 also applies to similarly numbered or arranged components of the electrical box assemblies 200, 300, 400. For example, the electrical box assemblies 200, 300, 400 of FIGS. 10-15 may generally include similar features as the electrical box assembly 100 of FIGS. 1-9 including but not limited to an electrical box 202, 302, 402 with an electrical box housing 216, 316, 416; an extendable sleeve 218, 318, 418, with mounting tabs 250, 350, 450 for receiving device fasteners (e.g., device fasteners 52 as shown in FIG. 9), movable within the electrical box housing 216, 316, 416 between a retracted position and an extended position; a back plate 222, 322, 422, with a far side support 234, 334, 434, removably attached to the electrical box housing 216, 316, 416; and a centerplate 204, 304, 404, including a first centerplate half 204a, 304a, 404a and a second centerplate half 204b, 304b, 404b, secured to the electrical box housing 216, 316, 416.

In some aspects, however, the electrical box assemblies 200, 300, 400, differ from the electrical box assembly 100 and each other. For example, the electrical box 202 is sized as a 4-gang electrical box, the electrical box 302 is a 5-gang electrical box, and the electrical box 402 is a 6-gang electrical box. The first centerplate halves 204a, 304a, 404a and the second centerplate halves 204b, 304b, 404b are spaced increasingly farther apart due to the increasing widths of the electrical boxes 202, 302, 402. Additionally, each electrical box assembly 200, 300, 400, includes a set of (i.e., more than one) housing tabs 224, 324, 424, sleeve tabs 246, 346, 446, and adjustment fasteners 228, 328, 428 to aid in providing sufficient balance between stability and case of adjustment of the extendable sleeves 218, 318, 418 due to the increased width thereof. For example, the electrical box assemblies 200, 300 each include a pair of each, spaced apart diagonally, and the electrical box assembly 400 includes four of each, arranged in a rectangular pattern. However, more or fewer housing tabs, sleeve tabs, and adjustment fasteners, and the arrangements thereof, are contemplated as may be required for providing sufficient stability and case of adjustment of the respective extendable sleeve. Furthermore, the electrical boxes 202, 302, 402 may include an increased number of mounting tabs 250, 350, 450 to secure a plurality of electrical devices (e.g., 4 or more electrical devices).

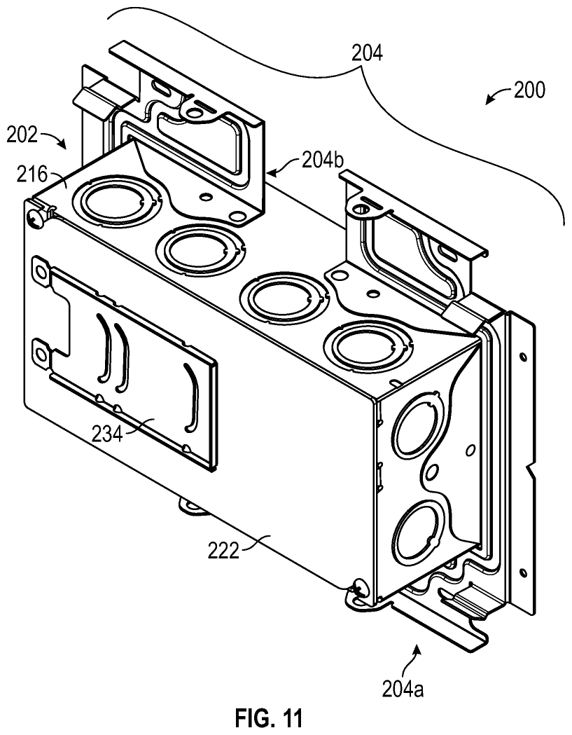

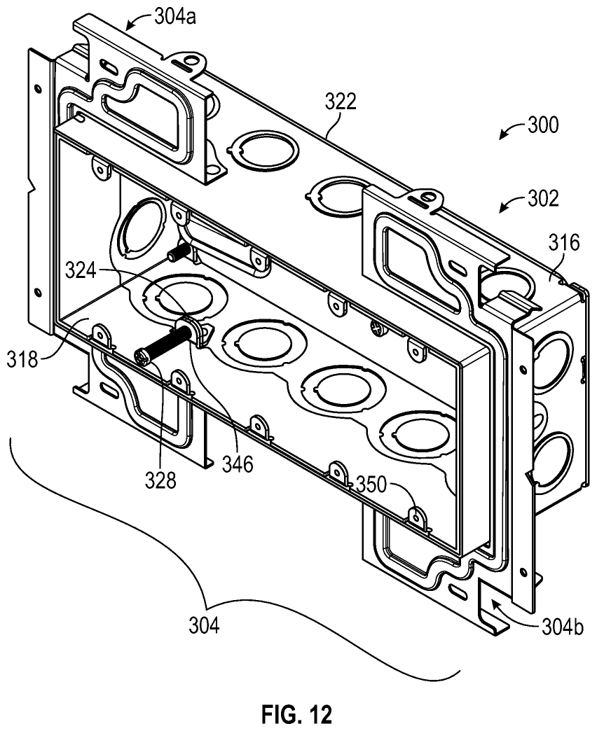

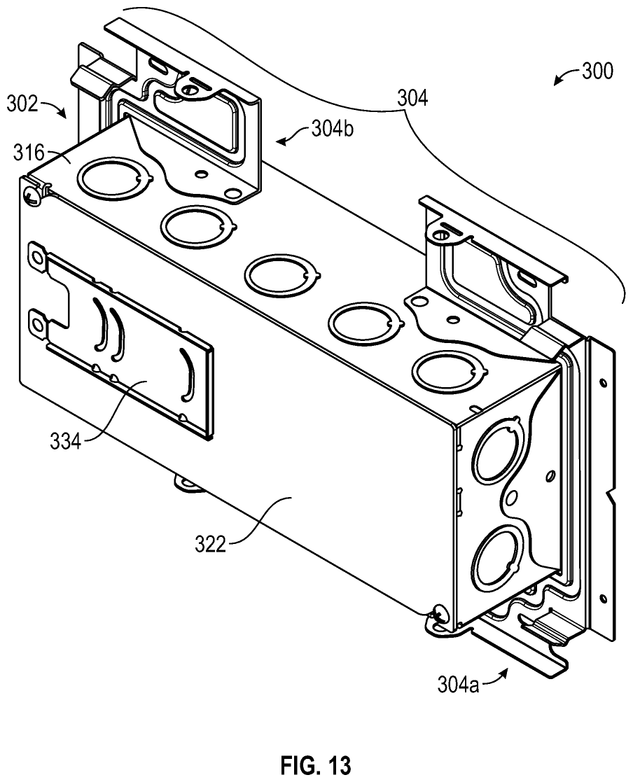

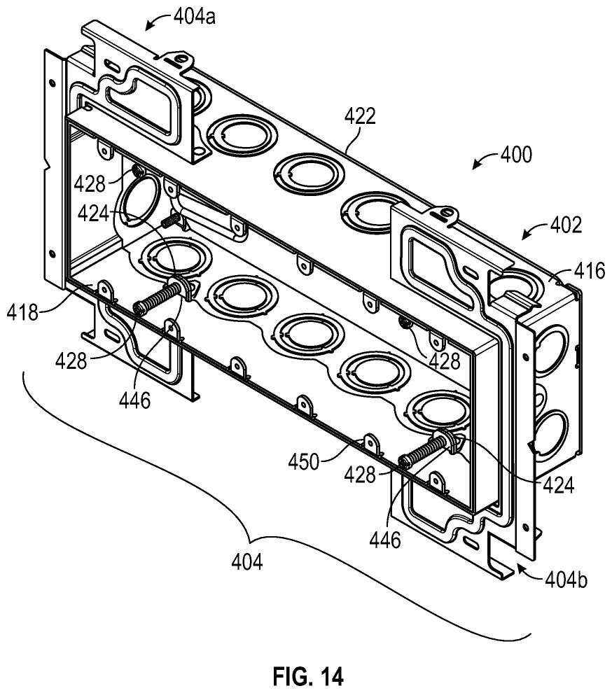

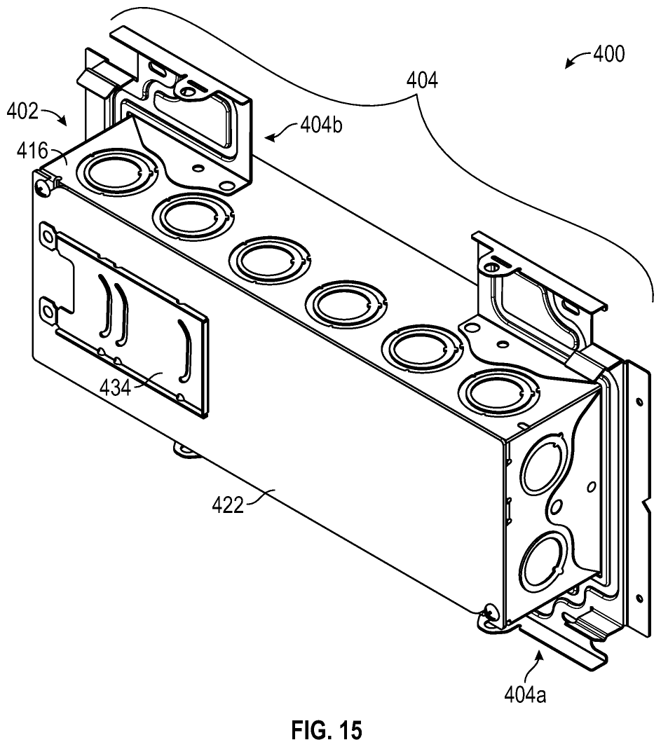

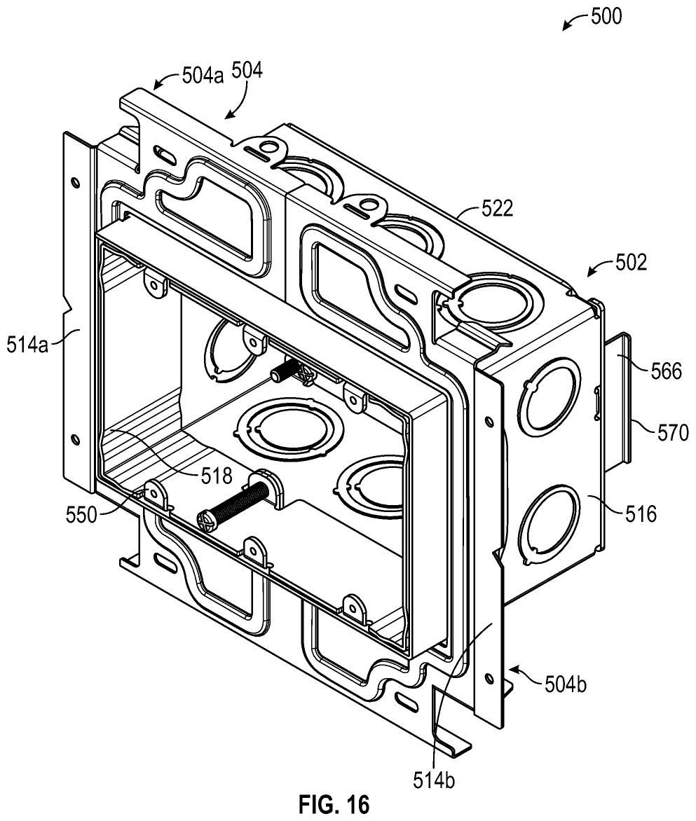

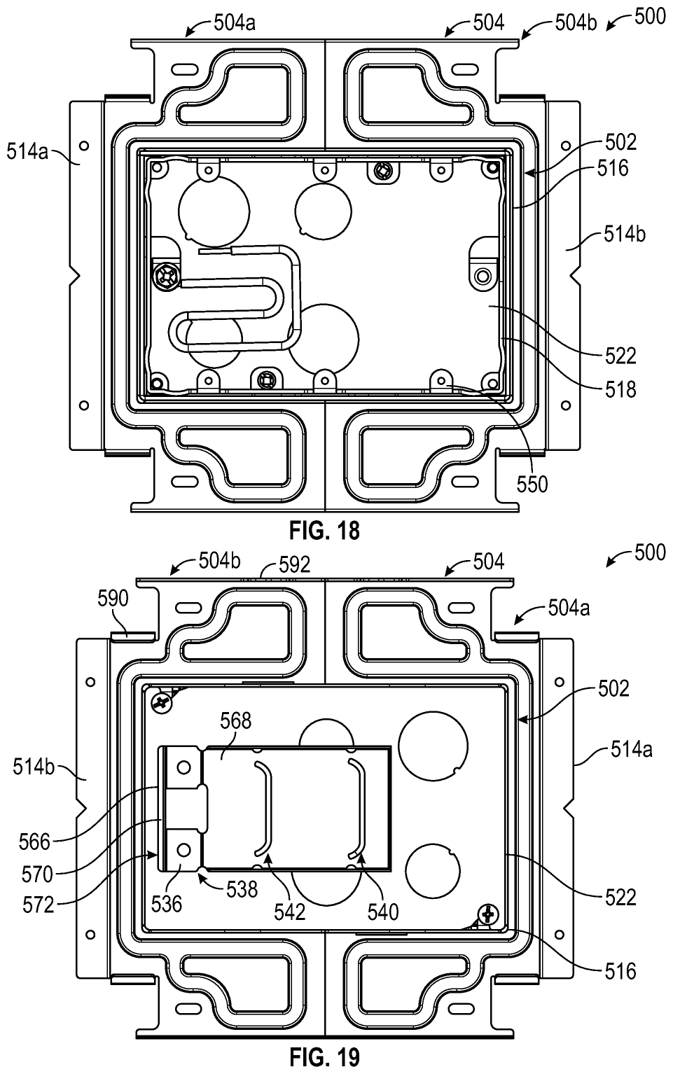

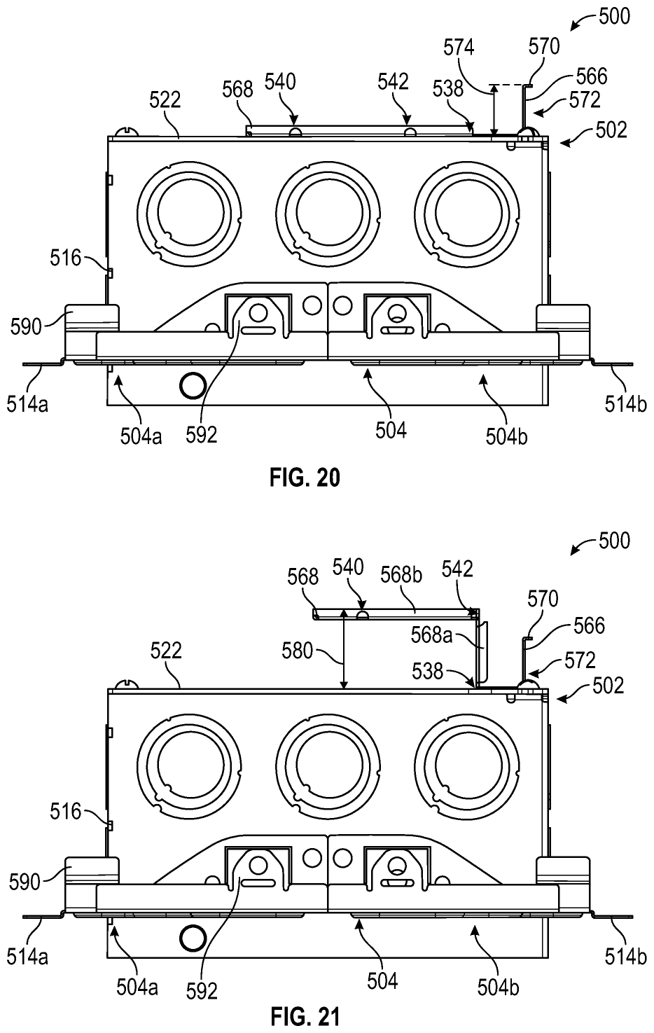

FIGS. 16-26 illustrate another embodiment of an electrical box assembly 500 according to an aspect of the invention. In many aspects, the electrical box assembly 500 is similar to the electrical box assemblies 100, 200, 300, 400 described above and similar numbering in the 500 series is used for the electrical box assembly 500. For example, the electrical box assembly 500 of FIGS. 16-26 may generally include similar features as the electrical box assembly 100 of FIGS. 1-9, electrical box assembly 200 FIGS. 10 and 11, electrical box assembly 300 of FIGS. 12 and 13, and electrical box assembly 400 of FIGS. 14 and 15 including but not limited to an electrical box 502 with an electrical box housing 516, an extendable sleeve 518 with mounting tabs 550 for receiving device fasteners (e.g., device fasteners 52 as shown in FIG. 9), movable within the electrical box housing 516 between a retracted position and an extended position, a back plate 522, with a far side support removably attached to the electrical box housing 516, the far side support having a plurality of reliefs to provide adjustable depth, and a centerplate 504 including a first centerplate half 504a and a second centerplate half 504b having first and second mounting flanges 514a, 514b, respectively, secured to the electrical box housing 516.

In some aspects, however, the electrical box assembly 500, may differ from the electrical box assemblies 100, 200, 300, 400. For example, the electrical box 502 may include the back plate 522 having a differently configured far side support. Similar to the far side support 134 discussed above, the far side support of the electrical box assembly 500 can be arranged to accommodate multiple inner wall depths. However, the far side support of the electrical box assembly 500 can provide a combination of a fixed far side support 566 and an adjustable far side support 568.

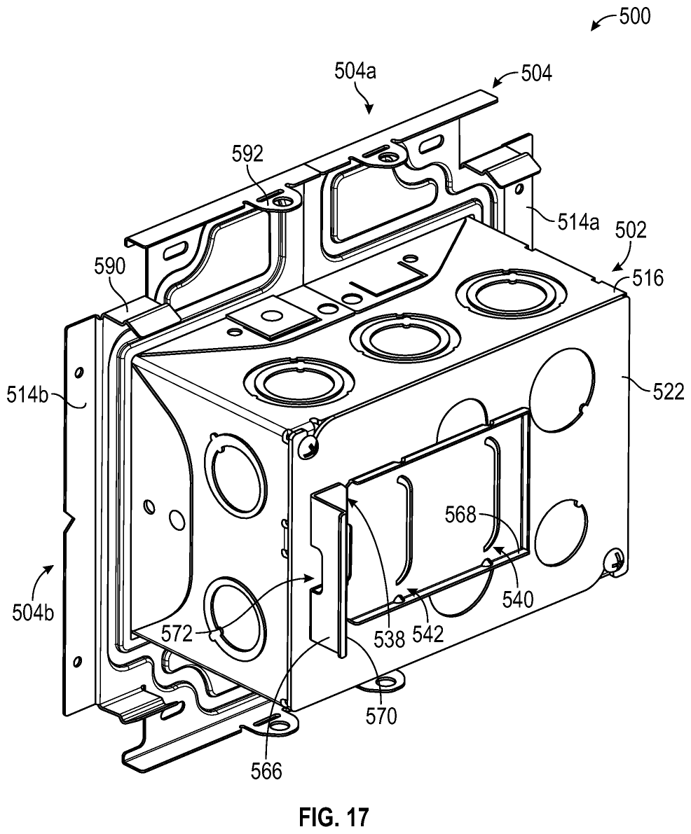

Referring to FIGS. 17, 19, and 20, the fixed far side support 566 and the adjustable far side support 568 may be coupled to the back plate 522 at a far side joint 536 utilizing spot welding, rivets, fasteners, or any other known fastening mechanism. In some embodiments, the fixed far side support 566 and the adjustable far side support 568 may each extend integrally from the far side joint 536. As such, the fixed far side support 566 and the adjustable far side support 568 may be integrally formed with each other.

As illustrated in FIG. 19, the fixed far side support 566 may rigidly and permanently extend substantially perpendicular to the back plate 522. As illustrated in FIG. 17, the fixed far side support 566 may extend from the back plate 522 to a lip 570. The lip 570 may extend from the fixed far side support 566 at a distal bend (e.g., a bend in the fixed far side support 566 arranged opposite the back plate 522). The lip 570 may extend transverse to a portion of the fixed far side support 566 that is proximal to the lip 570. The lip 570 may therefore extend substantially parallel to the back plate 522. The lip 570 may be configured to stabilize and support the electrical box assembly 500 by contracting a face of a support structure opposite the back plate 522.

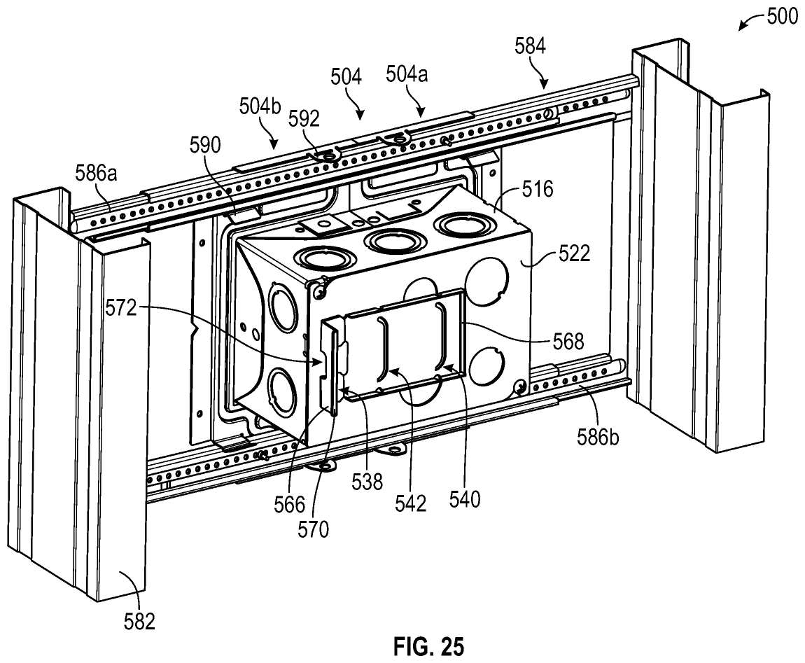

In some embodiments, the fixed far side support 566 may include a support aperture 572 (see, e.g., FIG. 25) extending between the back plate 522 and the lip 570. The support aperture 572 may act similar to the first relief 538, easing the bending of the fixed far side support 566 during manufacturing. Furthermore, during installation a combination of the lip 570 and the support aperture 572 may provide finger grips or hand holds, to case the removal and installation of the back plate 522.

Still referring to FIGS. 17, 19, and 20 the adjustable far side support 568 may function similar to the far side support 134. For example, the adjustable far side support 568 can be bent to a plurality of bent positions relative to the back plate 522 to provide support of the far side of the electrical box 502, in walls of different depths, by contacting an inside surface of a wall covering (e.g., drywall) attached to a face of a support structure opposite the back plate 522. Specifically, the adjustable far side support may include a first relief 538, a second relief 540, and a third relief 542, at which the adjustable far side support 568 can be selectively bent and which can correspond to common inner wall depths (e.g., 4″, 5½″, 6″).

As illustrated in FIGS. 17, 19, and 20 the far side support can be arranged in a first unbent position, in which the adjustable far side support 568 extends along and substantially parallel to the back plate 522 (e.g., unbent and otherwise unaltered from an as-shipped configuration). In the first unbent position, the electrical box assembly 500 may be supported by the fixed far side support 566. For example, the lip 570 of the fixed far side support 566 may be disposed a first distance 574 from the back plate 522 and the first distance 574 may thus be a minimum extension distance of the far side support. In the first bent position, the fixed far side support 566 may be configured to contact a building structure disposed about 3⅝ inches from the first and second mounting flanges 114a, 114b. The first bent position may therefore be utilized for installation in a wall space with an internal wall depth of 3⅝ inches.

As described above, to provide far side support for walls having an internal depth greater than 3⅝ inches, the adjustable far side support 568 can be selectively bent at first, second, or third reliefs 538, 540, 542 (e.g., substantially similar to the reliefs 138, 140, 142). In a second bent position, the adjustable far side support 568 can be bent at the first relief 138 (as shown in FIG. 23) to arrange the adjustable far side support 568 substantially perpendicular with respect to the back plate 522. Consequently, a distal end of the adjustable far side support 568 may be disposed a second distance 576 from the back plate 522. The second distance 576 may be a maximum extension distance of the adjustable far side support 568. In the second bent position, the adjustable far side support 568 can be configured to contact a building structure disposed about 6 inches from the first and second mounting flanges 114a, 114b. The second bent position may therefore be utilized for installation in a wall space with an internal wall depth of 6 inches.

Continuing, for installation in a wall space with an internal depth of between 3⅝ inches and 6 inches, the adjustable far side support 568 can be selectively bent at the second and third reliefs 540, 542 (or others, in various combinations), to adjust an extension of the adjustable far side support 568 relative to the back plate 522. For example, in a third bent position, as further detailed below, the adjustable far side support 568 can be bent a first time at the first relief 538, and can be bent a second time at the second relief 540 to reduce an extension of the adjustable far side support 568.

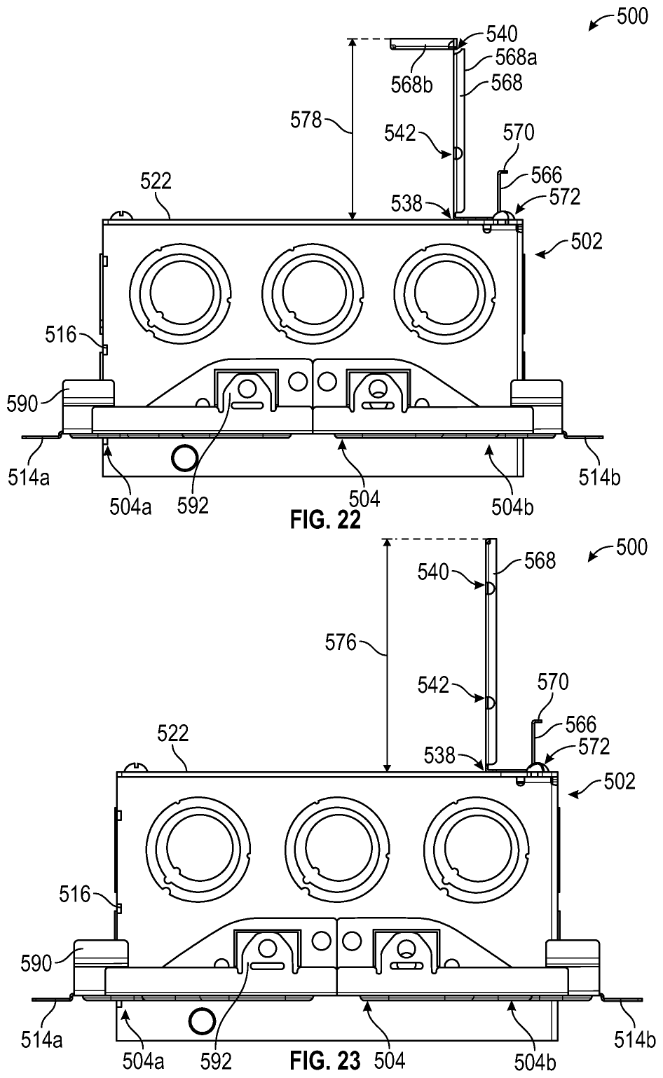

As illustrated in FIG. 22, a proximal portion 568a of the adjustable far side support 568 may extend substantially perpendicularly from the back plate 522 to a bend at the second relief 540. Furthermore, a distal portion 568b of the adjustable far side support 568 may extend from the bend at the second relief 540 transverse to the proximal portion 568a. The distal portion 568b may therefore be arranged substantially parallel with the back plate 522. In the third bent position, the distal portion 568b may be spaced a third distance 578 (e.g., a distance farther than the first distance and shorter than the second distance) from the back plate 522. In the third bent position the adjustable far side support 568 can be configured to contact a building structure disposed about 5 ½ inches from the first and second mounting flanges 114a, 114b. The third bent position may therefore be utilized for installation in a wall space with an internal wall depth of 5½ inches.

Referring to FIG. 21, in a fourth bent position, the adjustable far side support 568 can be bent a first time at the first relief 538, and can be bent a second time at the third relief 542 to reduce an extension of the adjustable far side support 568. In the fourth bent position, a proximal portion 568a of the adjustable far side support 568 may extend substantially perpendicularly from the back plate 522 to a bend at the third relief 542. Furthermore, a distal portion 568b of the adjustable far side support 568 may extend from the bend at the third relief 542 transverse to the proximal portion 568a. The distal portion 568b may therefore be arranged substantially parallel with the back plate 522. In the fourth bent position, the distal portion 568b may be spaced a fourth distance 580 (a distance farther than the first distance and shorter than the second and third distances) from the back plate 522. In the fourth bent position the adjustable far side support 568 can be configured to contact a building structure disposed about 4 inches from the first and second mounting flanges 114a, 114b. The fourth bent position may therefore be utilized for installation in a wall space with an internal wall depth of 4 inches. In other embodiments, more or fewer reliefs and bent positions may be utilized to adjust an extension of the adjustable far side support 568.

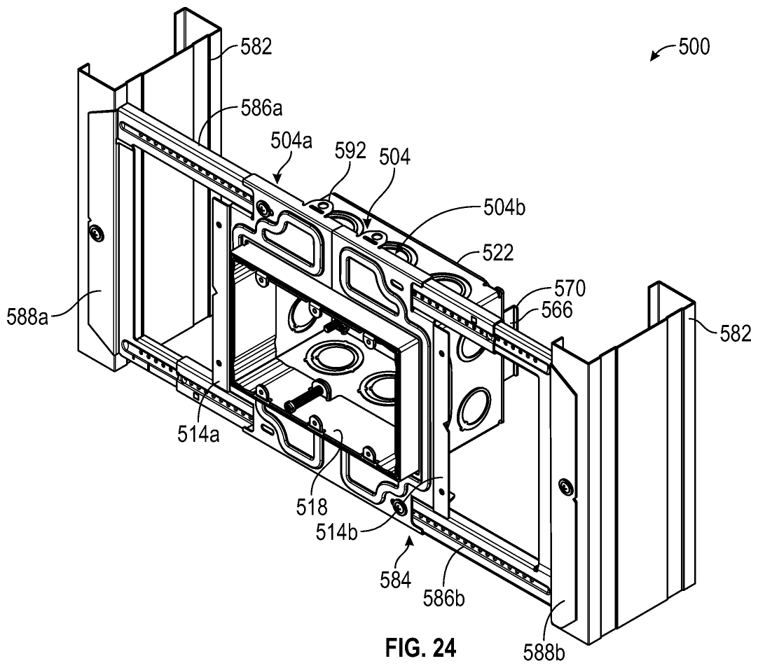

FIGS. 24 and 25 illustrate the electrical box assembly 500 supported between two support structures 582 (e.g., studs). The electrical box assembly 500 can be secured to the support structures 582 utilizing a box support bracket 584. In some examples, as illustrated, the box support bracket 584 can include a first support rail 586a and a second support rail 586b extending between a first bracket flange 588a and a second bracket flange 588b. The box support bracket 584 may be fastened to the support structures 582 at the first and second bracket flanges 588a, 588b. Furthermore, the electrical box assembly 500 may be mounted to the first and second support rail 586a, 586b to suspend the electrical box assembly 500 between the support structures 582.

In particular, the electrical box assembly 500 may be mounted to the box support bracket 584 utilizing the centerplate 504. As illustrated in FIG. 25, the centerplate 504 may include a first arm 590 that extends to engage with a first side of the first support rail 586a, and a second arm 592 that extends to engage with a second side of the first support rail 586a that is opposite the first side. As illustrated in FIG. 25, in some embodiments, multiple sets of the first and second arms 590, 592 may be utilized to secure the centerplate 504 to the first and second support rails 586a, 586b. In some embodiments, the first and second arms 590, 592 may cooperatively secure the electrical box assembly 500 to the box support bracket 584. For example, the first arm 590 may be a spring arm configured to resiliently deform to engage the first support rail 586a. Furthermore, the second arm 592 may be a bendable tab that is deformable about the first support rail 586a. However, in other embodiment, other configurations are possible. For example, either the first and second arms 590, 592 may be a spring arm, bendable tab, or other configuration of securement arm.

As illustrated in FIGS. 24 and 25, the electrical box assembly 500 suspended between two support structures 582 may not utilize the adjustable far side support 568 to support the electrical box assembly 500 relative a wall covering (not shown) secured to the support structures 582 opposite the electrical box assembly 500. However, in other embodiments, the adjustable far side support 568 can be bent to contact the wall covering (not shown) to support the electrical box assembly 500 relative to the wall covering (not shown) and the support structures 582.

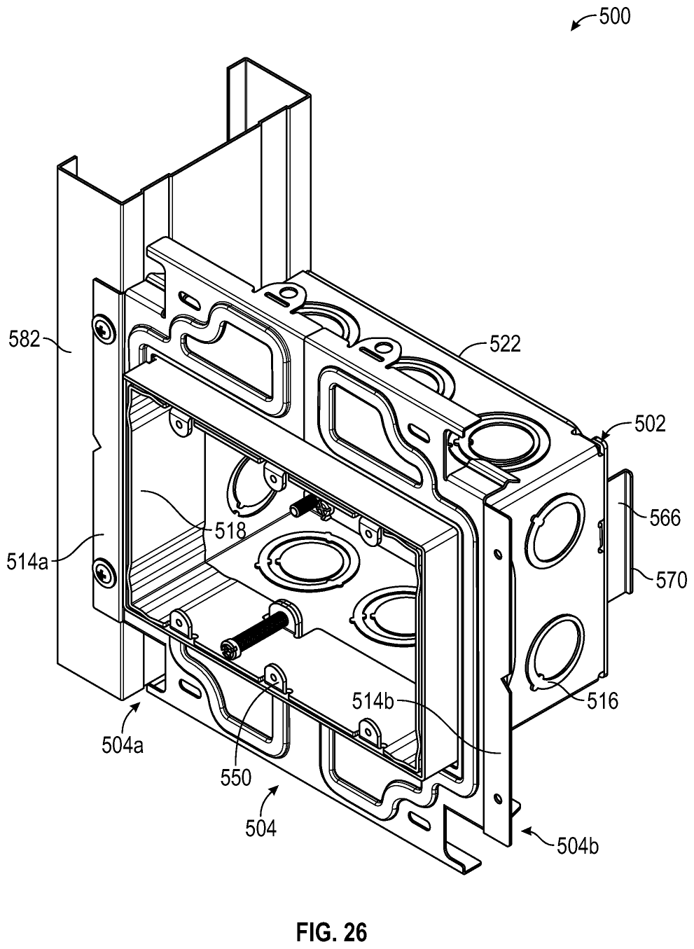

Referring to FIG. 26, in some embodiments, the electrical box assembly 500 can be directly supported by one of the support structures 582. For example, as illustrated, the first mounting flange 514a of the centerplate 504 may be fastened to the support structure 582 utilizing one or more fasteners. The first mounting flange 514a may therefore suspend the electrical box assembly 500 relative to the support structure 582. Furthermore, as illustrated the back plate 522 may be oriented to position the far side support (e.g., the adjustable far side support 568 and the fixed far side support 566) at the lateral side of the electrical box 502 that is farthest from the support structure 582 to which the electrical box assembly 500 is mounted). The far side support in the illustrated position may help to mitigate rotation of the electrical box assembly 500 relative to the support structure 582 during and after installation. However, as described above in relation to the back plate 122, the back plate 522 can instead be rotated and installed to position the far side support adjacent a side of the electrical box assembly that is nearest the support structure 582.

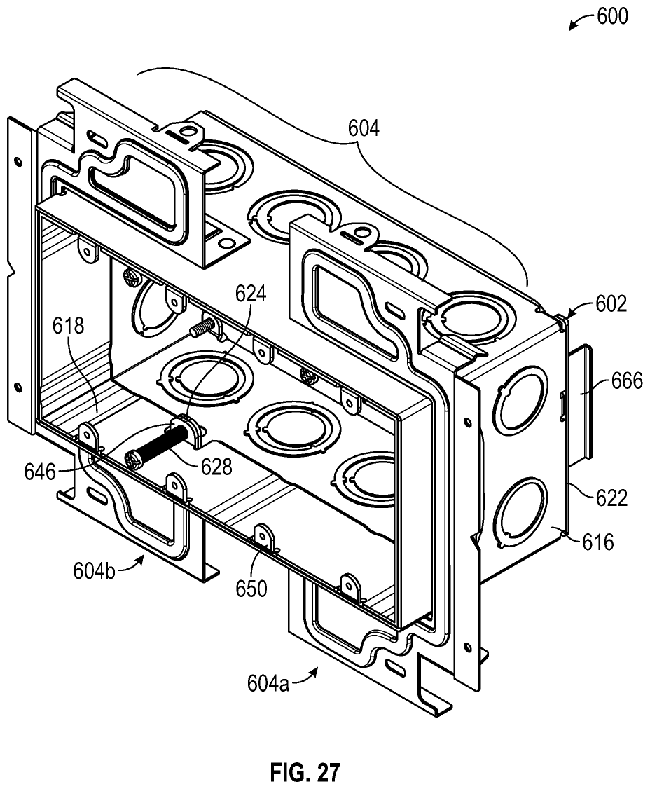

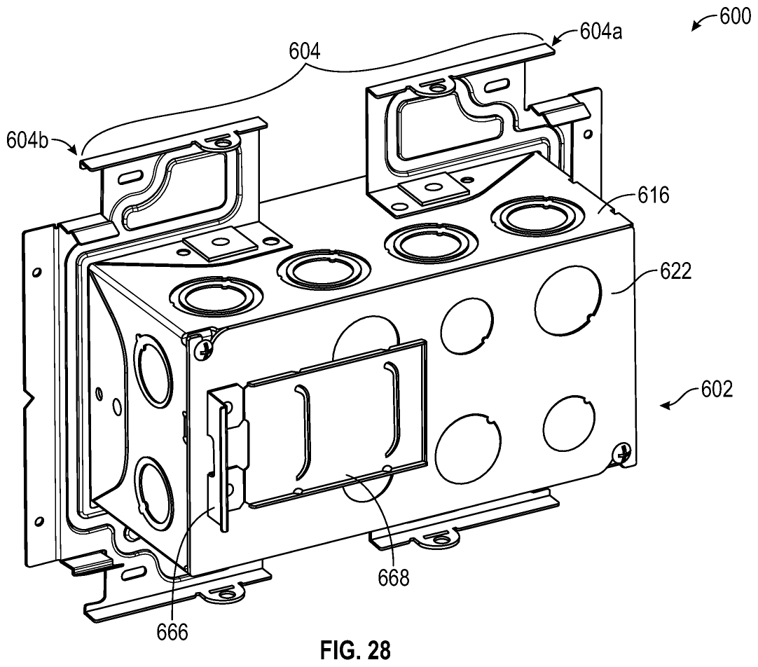

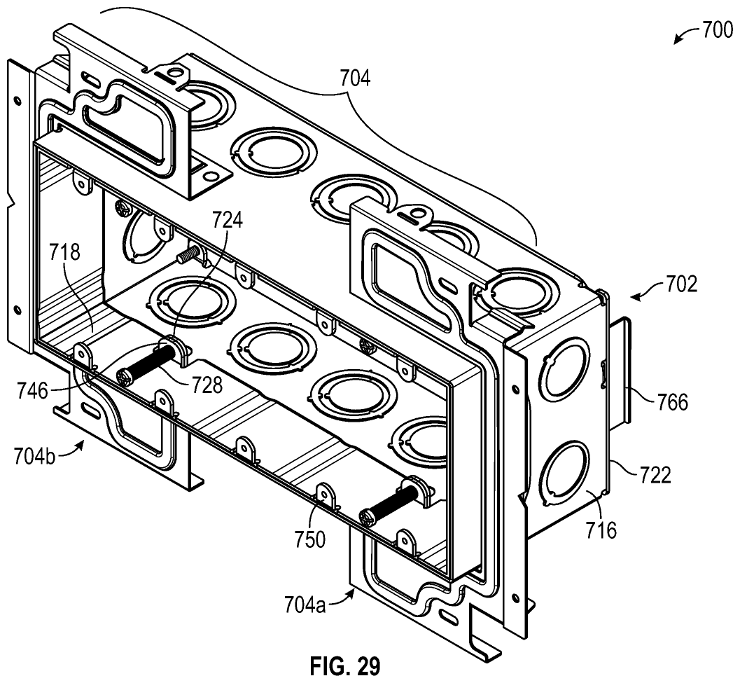

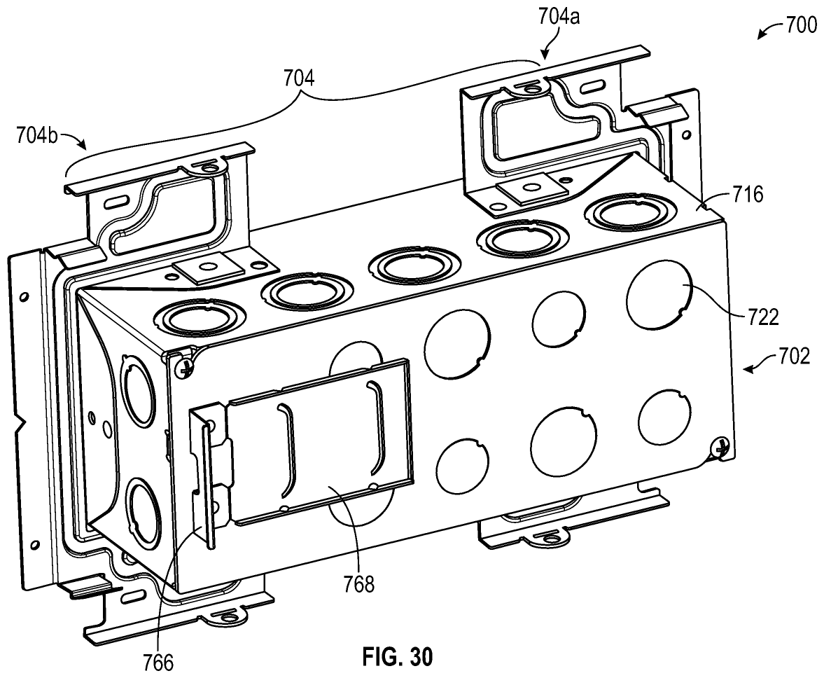

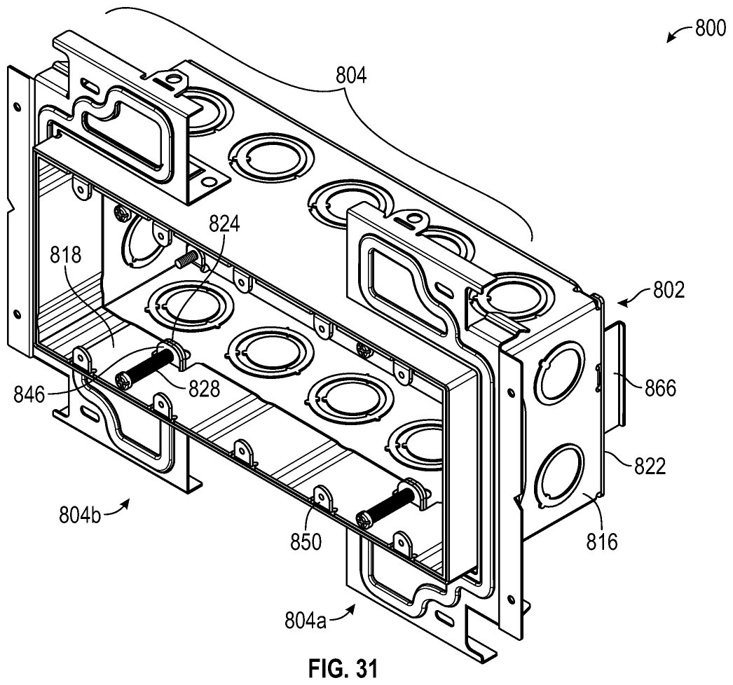

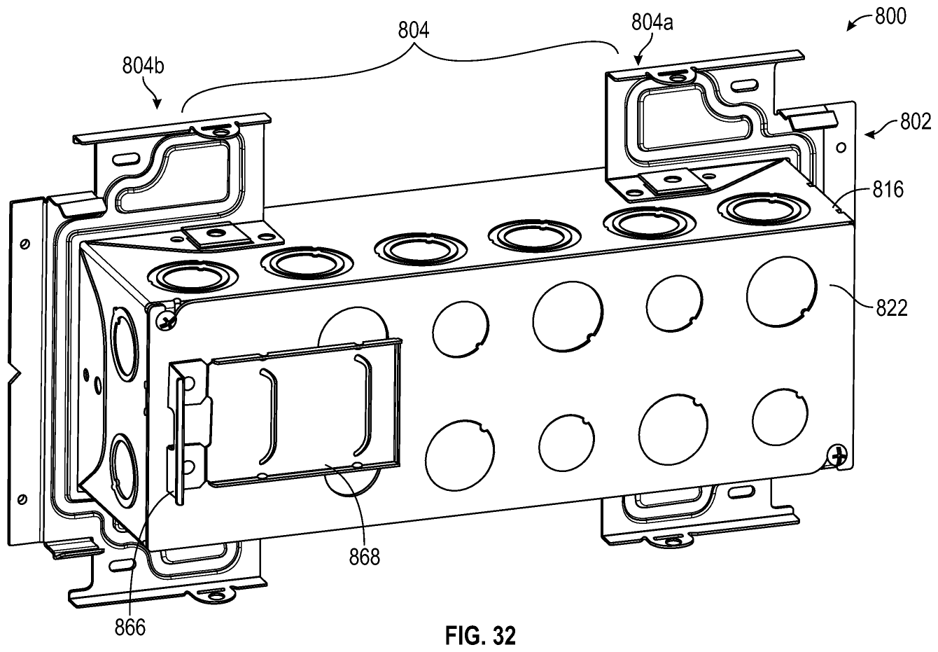

FIGS. 27 through 32 illustrate other embodiments of an electrical box assembly 600, 700, 800 according to the invention, as also can be mounted to structural support member. In many aspects, the electrical box assemblies 600, 700, 800 are similar to the electrical box assemblies 100, 200, 300, 400, 500 described above and similar numbering in the 600, 700, and 800 series are used for the electrical box assemblies 600, 700, and 800, respectively. For example, the electrical box assemblies 600, 700, 800 of FIGS. 27-32 may generally include similar features as the electrical box assembly 100 of FIGS. 1-9, electrical box assembly 200 FIGS. 10 and 11, electrical box assembly 300 of FIGS. 12 and 13, electrical box assembly 400 of FIGS. 14 and 15, and electrical box assembly 500 of FIG. 16-26 including but not limited to an electrical box 602, 702, 802 with an electrical box housing 616, 716, 816; an extendable sleeve 618, 718, 818, with mounting tabs 650, 750, 850 for receiving device fasteners (e.g., device fasteners 52 as shown in FIG. 9), movable within the electrical box housing 616, 716, 816 between a retracted position and an extended position; a back plate 622, 722, 822, with a far side support having an adjustable far side support 668, 768, 868 and a fixed far side support 666, 766, 866, removably attached to the electrical box housing 616, 716, 816; and a centerplate 604, 704, 804, including a first centerplate half 604a, 704a, 804a and a second centerplate half 604b, 704b, 804b, secured to the electrical box housing 616, 716, 816. In some examples the centerplate 604, 704, 804 can be identical to the centerplate 504.

In some aspects, however, the electrical box assemblies 600, 700, 800, differ from the electrical box assembly 100, 500 and each other. For example, similar to the electrical box assemblies 200, 300, 400 described above, the electrical box assemblies 600, 700, 800 may include different sized electrical boxes 602, 702, 802. The electrical box 602 is sized as a 4-gang electrical box, the electrical box 702 is a 5-gang electrical box, and the electrical box 802 is a 6-gang electrical box. The first centerplate halves 604a, 704a, 804a and the second centerplate halves 604b, 704b, 804b are spaced increasingly farther apart due to the increasing widths of the electrical boxes 602, 702, 802. Additionally, each electrical box assembly 600, 700, 800, includes a set of (i.e., more than one) housing tabs 624, 724, 824, sleeve tabs 646, 746, 846, and adjustment fasteners 628, 728, 828 to aid in providing sufficient balance between stability and case of adjustment of the extendable sleeves 618, 718, 818 due to the increased width thereof. For example, the electrical box assemblies 600, 700 each include a pair of each, spaced apart diagonally, and the electrical box assembly 800 includes four of each, arranged in a rectangular pattern. However, more or fewer housing tabs, sleeve tabs, and adjustment fasteners, and the arrangements thereof, are contemplated as may be required for providing sufficient stability and case of adjustment of the respective extendable sleeve. Furthermore, the electrical boxes 602, 702, 802 may include an increased number of mounting tabs 650, 750, 850 to secure a plurality of electrical devices (e.g., 4 or more electrical devices).

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

The discussion above is framed relative to particular electrical boxes and brackets and associated arrangements. However, those of skill in the art will recognize that this discussion implicitly also discloses various methods of adjustably mounting electrical boxes relative to support structures. Similarly, as also discussed above, the particular configurations of the electrical box and other components expressly described and illustrated in the various embodiments are presented as examples only, and the concepts disclosed herein can be used to adjustably secure electrical boxes (or other components) relative to a variety of support bracket configurations and support structures. In this regard, for example, electrical box assemblies according to some embodiments can be configured for attachment to between-stud supports, as integral parts of between-stud supports, for attachment directly to building studs or other building structures, and so on. Further, specific features discussed in detail relative to certain embodiments can be generally configured or used similarly with other embodiments, including relative to similar features on those embodiments or as substitutions or additions to those embodiments. Additionally, the proposed invention should not be viewed as limited to only 3-gang, 4-gang, 5-gang, or 6-gang rectangular electrical box assemblies, because the features disclosed herein could be applied to other sizes and shapes of electrical boxes.

Thus, embodiments of the invention can provide adjustability of electrical boxes. For example, some embodiments can provide extendable sleeves that allow an electrical box to be adjusted among any number of different finishing depths relative to an outward facing surface of a wall cover, including any number of different mounting depths along a continuous range of depths.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise specified or limited, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

Unless otherwise specified or limited, the terms “about” and “approximately,” as used herein with respect to a reference value, refer to variations from the reference value of ±15% or less (e.g., ±10%, ±5%, etc.), inclusive of the endpoints of the range.

Also as used herein, unless otherwise limited or defined, “substantially parallel” indicates a direction that is within ±12 degrees of a reference direction (e.g., within ±6 degrees or ±3 degrees), inclusive. Also as used herein, unless otherwise limited or defined, “substantially perpendicular” indicates a direction that is within ±12 degrees of perpendicular a reference direction (e.g., within ±6 degrees or ±3 degrees), inclusive. Discussion herein of directions “transverse” to a reference direction indicate directions that are not substantially parallel to the reference direction. Correspondingly, some transverse directions may be perpendicular or substantially perpendicular to the relevant reference direction.

Additionally, as used herein, unless otherwise specified or limited, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An electrical box assembly for adjustable-depth mounting of an electrical box relative to a support structure, the electrical box assembly comprising:
a centerplate with a centerplate opening;
an electrical box, including:
an electrical box housing,
a back plate removably attached to the electrical box housing;
an extendable sleeve that includes a plurality of mounting tabs arranged to secure three or more electrical devices at an open front side of the extendable sleeve;
the electrical box received within the centerplate opening, with the electrical box housing secured to the centerplate; and
the extendable sleeve selectively slidable within the electrical box housing.

2. The electrical box assembly of claim 1, wherein the extendable sleeve is moved between a retracted position and an extended position by an adjustment fastener, wherein the adjustment fastener is axially fixed but rotatable relative to the electrical box housing.

3. The electrical box assembly of claim 2, wherein the adjustment fastener is accessible, inside the electrical box, through the open front side of the extendable sleeve, to move the extendable sleeve between the retracted position and the extended position and through the extendable sleeve.

4. The electrical box assembly of claim 2, wherein the adjustment fastener is axially fixed to a housing tab extending inward from a side wall of the electrical box housing.

5. The electrical box assembly of claim 1, wherein the centerplate has a plurality of plate arms extending from a plate body, the plurality of plate arms fixedly secured to the electrical box housing.

6. The electrical box assembly of claim 1, wherein the back plate includes an adjustable far side support that is selectively bendable to a plurality of orientations corresponding to a plurality of distances between the back plate and a building structure opposite the back plate.

7. The electrical box assembly of claim 6, wherein the adjustable far side support includes a plurality of reliefs that define a plurality of bend locations corresponding to the plurality of distances.

8. The electrical box assembly of claim 7, wherein the adjustable far side support includes a first relief corresponding to a first extension distance, and a second relief corresponding to a second extension distance; and
wherein the back plate further includes a fixed far side support extending from the back plate at a third extension distance smaller than the first extension distance and the second extension distance.

9. The electrical box assembly of claim 8, wherein the fixed far side support is integral with the adjustable far side support.

10. The electrical box assembly of claim 1, further including a grounding tab extending from a side wall of the electrical box housing to attach an equipment grounding conductor for the three or more electrical devices.

11. The electrical box assembly of claim 1, wherein the centerplate is secured to a support rail by a first arm that extends to engage with a first side of the support rail, and a second arm that extends to engage with a second side of the support rail that is opposite the first side.

12. The electrical box assembly of claim 11, wherein the centerplate includes a set of partial centerplate portions that are secured to the electrical box housing spaced apart from each other.

13. An adjustable depth electrical box comprising:
an electrical box housing;
a back plate removably attached to the electrical box housing, the back plate including a far side support that is selectively adjustable to a plurality of extension distances to support the electrical box housing relative to a building structure opposite the back plate;
an extendable sleeve positioned at least partially within the electrical box housing to secure one or more electrical devices; and
an adjustment fastener axially fixed relative to the electrical box housing and rotatable relative to the electrical box housing to move the extendable sleeve between a retracted position and an extended position.

14. The adjustable depth electrical box of claim 13, wherein the far side support is bendable relative to the back plate at a first relief, to selectively adjust the far side support between:
an unbent position, in which a proximal portion of the far side support extends substantially in parallel with the back plate; and
a first bent position, wherein the proximal portion of the far side support extends substantially perpendicular to the back plate.

15. The adjustable depth electrical box of claim 14, wherein the far side support is bendable relative to the back plate at a second relief, to selectively adjust a distal portion of the far side support to a second bent position, in which the distal portion of the far side support extends transverse to the proximal portion at a first distance from the back plate; and
wherein the far side support is bendable relative to the back plate at a third relief, to selectively adjust the distal portion of the far side support to a third bent position, in which the distal portion of the far side support extends transverse to the proximal portion at a second distance from the back plate.

16. The adjustable depth electrical box of claim 15, wherein the far side support includes a fixed support that rigidly extends substantially perpendicular to the back plate.

17. A method of installing an electrical box assembly, the method comprising:
affixing a centerplate of the electrical box assembly to a building support structure, to support a housing of an electrical box relative to the building support structure, with an extendable sleeve of the electrical box: slidably supported within the housing; and supporting electrical devices at a front side of the electrical box assembly;
installing a back plate on a far side of the electrical box housing; and
adjusting the extendable sleeve of the electrical box housing relative to the electrical box housing to change a depth of the electrical devices relative to the building support structure.

18. The method of claim 17, further comprising:
selectively adjusting a far side support that is secured to the back plate, to support the electrical box housing relative to a building structure opposite the back plate, by selectively:
bending the far side support to a first bent position, in which the far side support extends substantially perpendicular to the back plate; or
bending the far side support to a second bent position, in which a distal portion of the far side support extends substantially parallel to the back plate.

19. The method of claim 17, wherein adjusting the extendable sleeve includes rotating an adjustment fastener that is axially fixed to a housing tab that extends inward from a side wall of the electrical box housing.

20. The method of claim 19, wherein rotating the adjustment fastener includes accessing the adjustment fastener through the front side of the electrical box assembly between electrical devices installed at the front side of the electrical box assembly.
